(19) United States
(12) Patent Application Publication
(10) Pub. No.: US 2006/0167188 A1
(43) Pub. Date: Jul. 27, 2006

(54) Novel coating compositions for high temperature pipes

(76) Inventors: Valerie Sauvant-Moynot, Lyon (FR); Alexandre Gaudilliere, Montfaucon (FR); Jacky Grenier, Vignieu (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/520,678

(22) PCT Filed: Jul. 2, 2003
(86) PCT No.: PCT/FR03/01719

§ 371 Date: Jan. 11, 2005

(30) Foreign Application Priority Data
Jul. 11, 2002 (FR) 0208713

(51) Int. Cl. C08L 71/02; C08L 63/00

(52) U.S. Cl. 525/396; 523/466

(57) ABSTRACT

The invention concerns a composition suitable for use as coating for a high temperature oil pipe, comprising at least one thermoplastic polymer selected from the group consisting of polyphenylenes ether or polysulphones, alone or mixed, at least one epoxy resin modified by at least one aromatic polyamine, said resin being formed from at least one polyepoxide containing it its molecule at least two epoxy groups and the aromatic polyamine containing in its molecule at least two primary amino groups, the polyamine, epoxide molar ratio being such that, to each amine group, there corresponds to 1.6 to 2.6 epoxy groups, and at least one filler preferably mineral having an anisometric morphology, preferably selected among the group consisting of silicates such as kaolin, and micaceous iron oxides.

The present invention relates to polymer compositions and their use especially for coating pipelines, preferably for coating hydrocarbon transport pipes used in offshore oil field exploitation.

In such an application, the principal role of a coating deposited on the outside of the pipeline onto metal is to protect the metal against corrosion induced by sea water, but the coating must also play a protective role against mechanical damage suffered by the pipe when placing it in position or in contact with the sea bottom. Further, current offshore oil developments, in particular the exploitation of high temperature fields where the temperature of the transported effluent exceeds 130° C., imposes a raft of ever more demanding requirements on pipe coating systems. External anti-corrosion coatings for transport pipelines must be deposited onto the steel using a conventional process, but this is limited to a temperature of 250° C. to prevent the steel microstructure from being modified. Further, environmental constraints require that non-polluting materials and processes be employed. Finally, at the operating temperature in sea water, the coating must have excellent properties of stability, adhesion to the steel and compatibility with cathodic protection systems. The majority of conventional coatings, however, for example certain powders based on epoxy resin sprayed onto the hot pipe, or polyolefins deposited in strips by extrusion, or polyurethanes cast onto the rotating pipeline, cannot tolerate a continuous operating temperature of more than 130° C. Such a temperature generally causes deformation of the polymer and its loss of adhesion to the metal forming part of the composition of the pipeline. As a result, in order to satisfy market demands, current technological limits in terms of coatings have to be pushed out to provide stability at temperatures of at least 140° C.

United States patent U.S. Pat. No. 6,239,232, for example, describes a composition acting as a coating for pipelines that not only allows a high operating temperature to be employed (up to 180° C. in general) but also, because a modified resin is introduced, allows the temperature for applying the composition to the metal pipeline to be reduced to between about 180° C. and 250° C.

During the course of studies carried out by the Applicant, it was discovered that introducing certain filler substances into polymer compositions acting as coatings for metal pipelines at high operating temperatures (for example those described in U.S. Pat. No. 6,239,232) not only significantly improved the mechanical strength of said coatings but also extended the operating temperature ranges of said coatings, and finally increased the performance of those coatings after application to their support. The Applicant has discovered that the stability of the coating on the pipeline and its behaviour under certain service conditions, in particular in sea water, depended largely on the water uptake of said coating, expressed in the present description as the mass of water absorbed (expressed as the percentage by weight) per hundred grams of coating. Too great a water uptake irreversibly results in plastification of the polymer material by water, encouraging blistering, cracking and finally detachment of the coating. In particular, the Applicant has discovered that a low water uptake provides long-term protection of the support from corrosion phenomena.

More precisely, the present invention concerns a composition for application as a coating for a high temperature oil pipeline, comprising at least one thermoplastic polymer selected from the group formed by ether polyphenylenes and polysulphones, used alone or as a mixture, at least one epoxy resin modified by at least one aromatic polyamine, said resin being formed from at least one polyepoxide containing at least 2 epoxy groups in its molecule and the aromatic polyamine containing at least 2 primary amine groups in its molecule, the mole ratio of the polyamine to the epoxy compound being such that each amine group corresponds to 1.6 to 2.6 epoxy groups, and at least one filler, preferably a mineral filler, in the form of particles having an anisometric morphology, preferably selected from the group formed by silicates in general, such as certain magnesium or aluminium silicates, in particular kaolin, and micaceous iron oxides.

The term “anisotropic morphology” (or non isometric morphology) as used in the present invention means that said particles have a morphology that preferably extends in one or more directions in space. As an example, fillers for use in the present invention can be in the form of fibrous, lamellar or, as is preferable, foliate particles.

The mean size of said particles can be in the range 1 to 250 μm, preferably in the range 1 to 100 μm, more preferably in the range 1 to 50 μm.

As an example, the greatest dimension of kaolin particles is advantageously in the range 1 to 30 μm, preferably in the range 3 to 10 μm. Similarly, the longest dimension of said micaceous iron oxide particles is in the range 1 to 60 μm. In general, the longest dimension of the particles is advantageously more than about 10 μm.

Said particles can have a form factor, defined as the ratio between their largest dimension and their smallest dimension, in the range about 5 to 500, limits included, preferably in the range about 5 to 100, limits included, and usually in the range about 10 to 50, limits included, for example in the range about 10 to 20, or in the range 20 to 40, limits included. Clearly, the present invention is not limited to form factors as described above and can in particular vary as a function of the chemical composition of the filler employed. Said values can in this case be adjusted using any known technique, in particular by comparative tests carried out using on particles with known dimensions.

The concentration by volume of said particles in the matrix can be in the range 1% to 50%, preferably in the range 5% to 40%, and usually in the range 10% to30%.

One or more particle types in accordance with the invention, differentiated by their chemical nature and/or their mean size and/or their form factor, can be incorporated into the same composition with a view to improving the properties described above. The mixture of several types of particles having different mean dimensions and/or form factors can be used to optimize the composition of the invention.

In accordance with the invention, the weight ratio between the thermoplastic polymer and the epoxy resin and the aromatic polyamine or precursors thereof can advantageously be in the range 70/30 to 30/70, preferably in the range 60/40 to 40/60.

The invention also concerns a coating obtained by applying a composition in accordance with one of the compositions described above to a generally metal support. In a variation, the coating is applied to the external surface of a pipeline.

Advantageously, the present compositions or coatings can be used in the oilfield exploitation, hydrocarbon transport or refining fields.

The epoxy resin used in the context of the present invention is usually selected from the group formed by the following commercial resins: the diglycidyl ether of bis-phenol A or bis-phenol F, bis-phenol formol resin, phenol-novolac resin, cycloaliphatic resins, tri- or tetra-functional resins, resins formed from triglycidylether-isocyanurate and/or triglycidylether-cyanurate and/or triglycidyl-cyanurate and/or triglycidyl-isocyanurate or mixtures of at least two of said resins. Epoxy resins obtained from epoxy compounds cited in U.S. Pat. No. 4,921,047 can also be used in the context of the present invention.

Examples of aromatic polyamines for use in the context of the present invention to modify the epoxy resins that can be considered are a first series of aromatic amines comprising a single aromatic ring, such as 3,5-dimethyl-2,4-diaminotoluene, 3,5-diethyl-2,6-diaminotoluene and mixtures of these two isomers. Usually, a mixture of these two isomers, known as DETDA, is used.

A second series of amines that can be used in the context of the present invention that can be considered is the series of amines comprising at least two aromatic rings, said two aromatic rings generally being connected together via a linear or branched divalent hydrocarbon residue containing 1 to 18 carbon atoms. Those two aromatic rings are either connected via a divalent alkyl group or are connected to each other via a linear or branched divalent hydrocarbon residue containing 6 to 18 carbon atoms and comprising an aromatic ring.

The aromatic polyamine can also comprise at least one substituent selected from the group formed by fluorine, iodine, bromine and chlorine. It preferably comprises at least two alkyl substituents, each being either side of an amino group.

When the two aromatic rings are connected via a divalent alkylene residue, that residue is preferably a non-substituted methylidene group, or a methylidene group substituted with at least one radical selected from alkyl radicals and halogenoalkyl radicals containing 1 to 3 carbon atoms. As an example, said alkylene residue is selected from the group formed by methylidene, isopropylidene, halogenoisopropylidene and hexafluoroisopropylidene groups. In this case, the amine is preferably selected from the group formed by:
4,4′-methylene-bis(2,6-dimethylaniline) or M-DMA;
4,4′-methylene-bis(2-isopropyl-6-methylaniline) or M-MIPA;
4,4′-methylene-bis(2,6-diethylaniline) or M-DEA;
4,4′-methylene-bis(2,6-diisopropylaniline) or M-DIPA; and
4,4′-methylene-bis(3-chloro-2,6-diethylaniline) or M-CDEA.

Of those amines, 4,4′-methylene-bis(2,6-diethylaniline) and 4,4′-methylene-bis(3-chloro-2,6-diethylaniline) are of particular interest.

When the amine comprises two aromatic rings which are connected together via a substituted or non substituted divalent hydrocarbon residue containing 6 to 18 carbon atoms and comprising an aromatic ring, it is preferably selected from the group formed by:
4,4′-(phenylene-diisopropyl)-bis(2,6-dimethylaniline);
4,4′-(phenylene-diisopropyl)-bis(2,6-diethylaniline);
4,4′-(phenylene-diisopropyl)-bis(2,6-dipropylaniline);
4,4′-(phenylene-diisopropyl)-bis(2,6-diisopropylaniline);
4,4′-(phenylene-diisopropyl)-bis(2,6-dimethyl-3-chloroaniline);
4,4′-(phenylene-diisopropyl)-bis(2,6-diethyl-3-chloroaniline);
4,4′-(phenylene-diisopropyl)-bis(2,6-dipropyl-3-chloroaniline);
4,4′-(phenylene-diisopropyl)-bis(2,6-diisopropyl-3-chloroaniline);
3,3-(phenylene-diisopropyl)-bis(2,6-dimethylaniline);
3,3-(phenylene-diisopropyl)-bis(2,6-diethylaniline);
3,3-(phenylene-diisopropyl)-bis(2,6-dipropylaniline);
3,3-(phenylene-diisopropyl)-bis(2,6-dimethyl-3-chloroaniline);
3,3-(phenylene-diisopropyl)-bis(2,6-diethyl-3-chloroaniline);
3,3-(phenylene-diisopropyl)-bis(2,6-dipropyl-3-chloroaniline);
3,3-(phenylene-diisopropyl)-bis(2,6-diisopropylaniline);
3,3-(phenylene-diisopropyl)-bis(2,6-diisopropyl-3-chloroaniline);

Preferred aromatic polyamines are selected for their low reactivity and non-toxic nature.

Within the context of the present invention, it is also possible to add to the composition a highly reactive hardener (i.e. with a reactivity that is greater than the principal hardener and usually very much greater) in small proportions, for example about 1% to 15% by weight and normally about 1% to 10% by weight with respect to the total composition weight.

The compositions of the present invention can also contain catalysts that are active for the reaction between the epoxy resins and the hindered aromatic polyamines. The most frequently used active catalysts are imidazoles, tertiary amines and trifluorinated boron-based complexes. The scope of the invention also encompasses adding other additives, usually selected from the group formed by antioxidants, pigments, adhesion promoters, heat and radiation (in particular ultraviolet radiation) stabilizers, flame retardants, unmoulding agents, dispersion agents, lubricants, colorants, plasticizers, flame resistant agents, bridging agents, surfactants, surface active agents, reinforcing agents, or mineral or organic reinforcing fibres such as glass, carbon or boron fibres.

The present invention will be better understood and its advantages will become clearer from the following examples.

In the examples below, the properties of the compositions of the invention are described in Examples 2 to 4 and are compared with those of a reference compound (Example 1) of the same nature but free of an additional filler substance, and with those of a composition comprising said reference formulation and a filler substance with a substantially isometric morphology (Example 5).

For each composition, measurements of steel adhesion, thermomechanical behaviour, stability to seawater and aging behaviour were carried out.

### EXAMPLE 1

In this example, a polymer composition comprising a polyphenylene-ether and a modified epoxy resin was prepared.

The modified epoxy resin comprised 8.016 kg of the diglycidyl ether of bisphenol A (DGEBA) sold by CIBA-GEIGY under the trade name LY556 and 3.984 kg of 4,4′-methylene-bis(3-chloro-2,6-diethylaniline) (MCDEA) sold by LONZA.

Prior to being introduced into the extruder, this stoichiometric mixture was heated to 80° C. with stirring. The reaction progress of this mixture was measured by size exclusion chromatography. The reactivity was very low: 5 hours at 60° C. resulted in 1% reaction.

The polyphenylene ether or PPE used is sold by GENERAL ELECTRIC under the trade name Blendex HPP820; its number average molecular mass is 12000 g/mol.

The modified epoxy resin was introduced into the extruder using a reciprocating pump at a constant rate of 1.30 kg/h. The polyphenylene ether was introduced at a rate of 2.00 kg/h using a weight metering hopper to obtain a composition containing 40% by weight of modified epoxy resin; the percentage of modified epoxy resin was calculated with respect to the total composition. The processing temperature of the mixture was about 180° C.

A homogeneous mixture was obtained from the extruder outlet; the conversion of reactive epoxy functions was less than 10%.

After extrusion, to carry out the adhesion measurements using a tensile-shear break test, the reference composition PPE60 was deposited on steel at a temperature of 220° C. then annealed at 220° C. for 2 hours.

The composition was then pressed into a mould at a pressure of 5 MPa to form a sheet with thickness 2×10⁻³ m and with a 120×10⁻³ m×120×10⁻³ m surface, and annealed at 220° C. for 2 hours. Subsequently, specimens were cut from the sheet to determine the thermomechanical properties of the composition, along with strips to determine the stability to seawater.

The adhesion properties of the composition in this example were determined using the tensile-shear break method (ASTM D1002). To determine the adhesion, three steel specimens, which had already been degreased with a stainless steel brush rotating at high speed, were bonded. The bonding surface was 25.4×10⁻³ m×12.7×10⁻³ m and the thickness of the bond constituted by said composition was 125 micrometers. Bonding was accomplished by simple contact at 220° C., which corresponded to the reduced processing temperature, then the different specimens were annealed for 2 hours at 220° C.

These tensile-shear break adhesion tests were carried out using an apparatus sold by INSTRON (INSTRON-1175) provided with a 100 kN (kilonewton) measuring head, using a cross-head speed of 10⁻³ m/min.

Examples 1.1 to 1.3 in Table 1a relate to three tensile-shear test specimens for the composition with reference PPE60 and Example 1.4 is the mean of the preceding results. For each specimen, the maximum load applicable prior to rupture was determined. By relating this value to the bonding surface, the stress at break under tensile-shear could be determined.

TABLE 1a

| Examples | 1.1 | 1.2 | 1.3 | 1.4 (mean) |
|---|---|---|---|---|
| Maximum load | 7.5 | 7.6 | 7.7 | 7.6 |
| (kilonewton) | | | | |
| Stress at break | 23.4 | 23.7 | 23.8 | 23.6 |
| (MPa) | | | | |

It can be seen from this first series of results that the mean stress at break in tensile-shear for the reference composition PPE60 was much higher than the values required for a coating application.

The thermomechanical properties of the polymer composition of the example were determined using DMTA (dynamic mechanical thermal analysis), single clamped. The measurement was carried out on a specimen of thickness 2×10⁻³ m thick, moulded and annealed as described above. The modulus of elasticity values were measured as a function of the temperature at a frequency of 1 Hz using a Polymer Laboratories DMTA apparatus.

The moduli of elasticity E′ at 25° C., 150° C., 180° C. and 220° C. were measured for reference composition PPE60 of the example. These values are shown in Table 1b.

TABLE 1b

| Example 1 | 25° C. | 150° C. | 180° C. | 220° C. |
|---|---|---|---|---|
| Moduli E′, MPa | 1260 | 990 | 610 | 70 |

The moduli of elasticity indicate the rigidity of the materials. According to these results, up to about 180° C., the reference composition has sufficient rigidity for application as a coating, but not beyond that temperature.

A stability to seawater test was also carried out. The annealed moulded 2×10⁻³ m thick sheet with the composition of the example was cut into strips with a surface of 50×10⁻³ m×50×10⁻³ m. Two specimens were immersed in synthetic seawater contained in a sealed reactor, heated to 160° C. at an absolute pressure of 0.62 MPa. Water absorption tests (or water takeup tests), expressed as the mass of water absorbed (expressed as the percentage by weight) per hundred grams of coating, were carried out by determining the variation in the mass of the specimens after 2 months and 4 months immersion. The mean results are shown in Table 1c.

TABLE 1c

| Example 1 | 2 months | 4 months |
|---|---|---|
| Water takeup (% by weight) | 1.40 | 1.40 |
| Deformation | None | None |

The reference composition specimens did not deform at all after 4 months immersion at 160° C., and had a completely unaltered appearance. The water takeup of the reference composition PPE60 was unchanged between 2 months and 4 months immersion, indicating that saturation equilibrium had been achieved.

### EXAMPLE 2

Example 2 was in accordance with the invention. In this example, a composition was prepared based on the reference composition PPE60 described in Example 1 and with kaolin, having an anisometric morphology.

The kaolin used (calcined aluminium silicate) is sold by OMYA, reference number Kaolin 2211. It has a specific density of 2.63 g/cm³. The mean particle size is 1.4 micrometres.

The PPE60 and kaolin were mixed in an extruder heated to 180° C. The PPE60 granules obtained after a first pass through the extruder using the protocol described in Example 1 were introduced via a reciprocating pump at a constant rate of 2.00 kg/h. The kaolin was introduced using a weight metering hopper at a rate of 1.20 kg/h to obtain a composition containing 20% by volume of kaolin with respect to the total composition.

At the extruder outlet, a homogeneous mixture of polymer was obtained, the conversion of reactive epoxy functions being less than 15%, filled with kaolin in an amount of 20% by volume.

After extrusion, the composition of Example 2 of the invention was applied and annealed using the protocols described in Example 1 to measure its steel adhesion, thermomechanical behaviour, stability to seawater and ageing behaviour. The form factor for the majority of said particles, measured from scanning electron microscope scans of said composition after said annealing, was in the range 10 to 20.

The adhesion properties of the composition of Example 2 of the invention were determined using the ASTM D1002 method using the process described in Example 1. The results are shown in Table 2a.

TABLE 2a

| Examples | 2.1 | 2.2 | 2.3 | 2.4 (mean) |
|---|---|---|---|---|
| Maximum load | 6.1 | 5.5 | 6.1 | 5.8 |
| (kilonewton) | | | | |
| Stress at break | 19 | 17 | 19 | 18 |
| (MPa) | | | | |

It can be seen from this series of results that the mean stress at break in tensile-shear of the composition of the invention is very good, and suitable for use as a coating for oil pipelines, as the relative values for the three specimens were all at least 15 MPa.

The thermomechanical properties of the polymer composition of Example 2 of the invention were determined using DMTA analysis, single clamped using the procedure described in Example 1.

The moduli of elasticity E′ at 25° C., 150° C., 180° C. and 220° C. are shown in Table 2b.

TABLE 2b

| Example 2 | 25° C. | 150° C. | 180° C. | 220° C. |
|---|---|---|---|---|
| Moduli E′, MPa | 2520 | 1990 | 1220 | 200 |

The moduli of elasticity indicate the rigidity of the materials. According to these results, the composition of Example 2 has sufficient rigidity for application as a coating up to a value of 220° C.

A stability to seawater test was also carried out on the composition of Example 2 of the invention by means of gravimetric measurements using the procedure described in Example 1. Water absorption measurements carried out by determining the variation in the mass of specimens after immersion for 2 to 4 months are shown in Table 2c.

TABLE 2c

| Duration | 2 months | 4 months |
|---|---|---|
| Water takeup (% by weight) | 1.27 | 1.28 |
| Deformation | None | None |

The specimens of Example 2 of the invention did not deform at all after 4 months immersion at 160° C. and had a completely unaltered appearance. The water takeup of the composition of Example 2 of the invention was stable between 2 months and 4 months immersion, indicating that saturation equilibrium had been achieved. The water takeup of the composition of Example 2 of the invention was particularly low.

### EXAMPLE 3

Example 3 was also in accordance with the invention. In this example, a composition was prepared based on the reference composition PPE60 described in Example 1 and with a micaceous iron oxide having an anisometric morphology.

The micaceous iron oxide used is sold by Kartner, reference number MIOX SF. It has a specific density of 4.80 g/cm³. 15% of the particles have a mean dimension of less than 44 micrometres and 30% of particles have a mean dimension of 32 micrometres; overall, the particles have a mean dimension of less than 74 micrometres.

The PPE60 and micaceous iron oxide were mixed in an extruder heated to 180° C. The PPE60 granules obtained after a first pass through the extruder using the protocol described in Example 1 were introduced using a reciprocating pump at a constant rate of 2 kg/h. The micaceous iron oxide was introduced using a weight metering hopper at a rate of 2.20 kg/h to obtain a composition containing 20% by volume of micaceous iron oxide with respect to the total composition.

At the extruder outlet, a homogeneous mixture of polymer was obtained, the conversion of reactive epoxy functions being less than 15%, filled with micaceous iron oxide in an amount of 20% by volume.

After extrusion, the composition of the example was applied and annealed using the protocols described in Example 1 to measure its steel adhesion, thermomechanical behaviour, stability to seawater and ageing behaviour. The form factor for the majority of said particles, measured from scanning electron microscope scans of said composition after annealing, was in the range 20 to 40.

The adhesion properties of the composition of Example 3 of the invention were determined using the ASTM D1002 method using the process described in Example 1. The results are shown in Table 3a.

TABLE 3a

| Examples | 3.1 | 3.2 | 3.3 | 3.4 (mean) |
|---|---|---|---|---|
| Maximum load | 7.1 | 7.3 | 6.9 | 7.1 |
| (kilonewton) | | | | |
| Stress at break | 22 | 23 | 21 | 22 |
| (MPa) | | | | |

It can be seen from this series of results that the mean stress at break in tensile-shear of the composition of the invention is very good, suitable for use as a coating for oil pipelines, as the relative values for the three specimens were all at least 20 MPa.

The thermomechanical properties of the polymer composition of Example 3 of the invention were determined using DMTA analysis, single clamped using the procedure described in Example 1.

The moduli of elasticity E′ at 25° C., 150° C., 180° C. and 220° C. are shown in Table 3b.

TABLE 3b

| Example 3 | 25° C. | 150° C. | 180° C. | 220° C. |
|---|---|---|---|---|
| Moduli E′, MPa | 3000 | 2010 | 990 | 220 |

The moduli of elasticity indicate the rigidity of the materials. According to these results, the composition of Example 3 of the invention has sufficient rigidity for application as a coating up to a value of 220° C.

A series of stability to seawater tests were also carried out on the composition of Example 3 of the invention by means of gravimetric measurements using the procedure described in Example 1. Water absorption measurements carried out by determining the variation in the mass of specimens after immersion for 2 to 4 months are shown in Table 3c.

TABLE 3c

| Duration | 2 months | 4 months |
|---|---|---|
| Water takeup (% by weight) | 1.14 | 1.15 |
| Deformation | None | None |

The specimens of Example 3 of the invention did not deform at all after 4 months immersion at 160° C. and had a completely unaltered appearance. The water takeup of the composition of Example 3 was stable between 2 months and 4 months immersion, indicating that saturation equilibrium had been achieved. The water takeup of the composition of Example 3 of the invention was particularly low.

### EXAMPLE 4

Example 4 was in accordance with a further variation of the invention. In this example, a composition was prepared based on the reference composition PPE60 described in Example 1 and a mixture of kaolin and micaceous iron oxide, described in Examples 2 and 3 respectively.

The PPE60, micaceous iron oxide and kaolin were mixed in an extruder heated to 1 80° C. The PPE60 granules obtained after a first pass through the extruder using the protocol described in Example 1 were introduced using a reciprocating pump at a constant rate of 2.00 kg/h. The micaceous iron oxide and kaolin mixture, pre-mixed in a ratio of 15/85 by volume, was introduced using a weight metering hopper at a rate of 1.30 kg/h to obtain a composition containing 20% by volume of particles with an anisometric morphology with respect to the total composition.

At the extruder outlet, a homogeneous mixture of polymer was obtained, the conversion of reactive epoxy functions being less than 15%, and filled with a 15/85 mixture of micaceous iron oxide and kaolin in an amount of 20% by volume.

After extrusion, the composition of Example 4 was applied and annealed using the protocols described in Example 1 to measure its steel adhesion, thermomechanical behaviour, stability to seawater and ageing behaviour.

The adhesion properties of the composition of Example 4 of the invention were determined using the ASTM D1002 method using the process described in Example 1. The results are shown in Table 4a.

TABLE 4a

| Examples | 4.1 | 4.2 | 4.3 | 4.4 (mean) |
|---|---|---|---|---|
| Maximum load | 6.1 | 6.4 | 6.9 | 6.4 |
| (kilonewton) | | | | |
| Stress at break | 19 | 20 | 21 | 20 |
| (MPa) | | | | |

It can be seen from this series of results that the mean stress at break in tensile-shear of the composition of Example 4 of the invention is very good, suitable for use as a coating for oil pipelines, as the relative values for the three specimens were all at least 20 MPa.

The thermomechanical properties of the composition of Example 4 of the invention were determined using DMTA analysis, single clamped using the procedure described in Example 1.

The moduli of elasticity E′ at 25° C., 150° C., 180° C. and 220° C are shown in Table 4b.

TABLE 4b

| Example 4 | 25° C. | 150° C. | 180° C. | 220° C. |
|---|---|---|---|---|
| Moduli E′, MPa | 2700 | 1910 | 1130 | 220 |

The moduli of elasticity indicate the rigidity of the materials. According to these results, the composition of Example 4 of the invention has sufficient rigidity for application as a coating up to a value of 220° C.

A series of stability to seawater tests were also carried out on the composition of Example 4 of the invention by means of gravimetric measurements using the procedure described in Example 1. Water absorption measurements carried out by determining the variation in the mass of specimens after immersion for 2 to 4 months are shown in Table 4c.

TABLE 4c

| Duration | 2 months | 4 months |
|---|---|---|
| Water takeup (% by weight) | 1.20 | 1.21 |
| Deformation | None | None |

The specimens of Example 4 of the invention did not deform at all after 4 months immersion at 160° C. and had a completely unaltered appearance. The water takeup of the composition of Example 4 was stable between 2 months and 4 months immersion, indicating that saturation equilibrium had been achieved. The water takeup of the composition of Example 4 of the invention was particularly low.

### EXAMPLE 5

Example 5 is not in accordance with the invention. In this example, a composition was prepared based on the reference composition PPE60 described in Example 1 and with particles of zinc phosphate, a filler substance with a substantially isometric morphology.

The zinc phosphate used is sold by SNCZ under the trade name Phosphinal PZ04. It has a specific density of 3.30 g/cm³. The zinc phosphate was in the form of a solid powder with a mean particle size of the order of a micron and with a form factor of close to 1.

The PPE60 and zinc phosphate were mixed in an extruder heated to 180° C. The PPE60 granules obtained after a first pass through the extruder using the protocol described in Example 1 were introduced using a reciprocating pump at a constant rate of 2 kg/h. The zinc phosphate was introduced using a weight metering hopper at a rate of 1.50 kg/h to obtain a composition containing 20% by volume of zinc phosphate particles with a substantially isometric morphology with respect to the total composition.

At the extruder outlet, a homogeneous mixture of polymer was obtained, the conversion of reactive epoxy functions being less than 15%, and filled with zinc phosphate in an amount of 20% by volume.

After extrusion, the composition of Example 5 was applied and annealed using the protocols described in Example 1 to measure their steel adhesion, thermomechanical behaviour, stability to seawater and ageing behaviour.

The adhesion properties of the composition of non-inventive Example 5 were determined using the ASTM D1002 method using the process described in Example 1. The results are shown in Table 5 a.

TABLE 5a

| Examples | 5.1 | 5.2 | 5.3 | 5.4 (mean) |
|---|---|---|---|---|
| Maximum load | 6.9 | 7.3 | 7.1 | 7.1 |
| (kilonewton) | | | | |
| Stress at break | 21 | 23 | 22 | 22 |
| (MPa) | | | | |

It can be seen from this series of results that the mean stress at break in tensile-shear of the composition of Example 5 of the invention is very good, as the relative values for the three specimens were all at least 15 MPa.

The thermomechanical properties of the composition of comparative Example 5 were determined using DMTA analysis, single clamped using the procedure described in Example 1.

The moduli of elasticity E′ at 25° C., 150° C., 180° C. and 220° C. are shown in Table 5b.

TABLE 5b

| Example 5 | 25° C. | 150° C. | 180° C. | 220° C. |
|---|---|---|---|---|
| Moduli E′, MPa | 2870 | 1740 | 1110 | 310 |

The moduli of elasticity indicate the rigidity of the materials. According to these results, the composition of comparative Example 5 has sufficient rigidity for application as a coating up to a value of at least 220° C.

A series of stability to seawater tests were also carried out on the composition of comparative Example 5 by means of gravimetric measurements using the procedure described in Example 1. Water absorption measurements carried out by determining the variation in the mass of specimens after immersion for 2 to 4 months are shown in Table 5c.

TABLE 5c

| Duration | 2 months | 4 months |
|---|---|---|
| Water takeup (% by weight)′1 | 12.50 | 14.20 |
| Deformation | marked | marked |

The specimens of comparative Example 5 exhibited deformation after 2 and 4 months immersion at 160° C. and appeared substantially altered (blistering and cracking). The water takeup of the composition of comparative Example 5 increased between 2 months and 4 months immersion, indicating that saturation equilibrium had not been achieved. Since the water takeup of the composition of Example 5 was particularly high and not stabilized, it can be concluded that said composition is sensitive to ageing in seawater at 160° C.

Examples 1 to 5 show the possibility of producing compositions from polyphenylene ether thermoplastic and modified resins, keeping the temperature for application of said compositions onto steel below 250° C. to produce good adhesion to the steel—in the examples, the stress at break in tensile-shear was at least 15 MPa.

However, applying a high temperature coating requires high rigidity under service conditions; by comparison with reference Example 1, Examples 2 to 4 demonstrate that introducing an anisometric filler into the polymer composition considerably improves the rigidity of the coating over the whole temperature range (100% or more gain in modulus between 25° C. and 180° C.), and also allows application of the coating at higher temperatures to be envisaged, between 180° C. and 220° C. (200% or more gain in modulus at 200° C.), which is not possible for the reference composition.

Further, consideration of the stability to seawater appears to be of vital importance for external coating of a pipeline in a marine medium. By comparison with reference Example 1, Examples 2, 3 and 4 of the invention clearly show that when the compositions comprise a substance with an anisometric morphology, the water takeup of the coating is considerably reduced compared with the reference composition of Example 1 (−10% for Example 2; −20% for Example 3; −14% for Example 4). In the present invention, it has been discovered that this reduction in water takeup conditions the anticorrosion performance of the coating over time. Thus, a composition comprising a filler with a substantially isometric morphology has an increased water takeup compared with that of the reference composition of Example 1 (+800%). In the present invention, it has been discovered that a large water takeup is associated with ageing of the coating of the composition, indicated by blistering and cracking.

Overall, these different experiments show that only the compositions of Examples 2 to 4 of the invention provide a satisfactory response in terms of adhesion, thermomechanical behaviour, water takeup and ageing with a view to applying high temperature coatings to pipelines in a marine medium.

1. A composition comprising at least one thermoplastic polymer selected from the group formed by ether polyphenylenes and polysulphones, used alone or as a mixture, at least one epoxy resin modified by at least one aromatic polyamine, said resin being formed from at least one polyepoxide containing at least 2 epoxy groups in its molecule and the aromatic polyamine containing at least 2 primary amine groups in its molecule, the mole ratio of the polyamine to the epoxy compound being such that each amine group corresponds to 1.6 to 2.6 epoxy groups, and at least one filler in the form of particles having an anisometric morphology and with a mean dimension in the range 1 to 250 μm.

2. A composition according to claim 1, in which said filler is selected from non isometric silicates.

3. A composition according to claim 1, in which said filler is a micaceous iron oxide.

4. A composition according to claim 1, in which said particles have a form factor, defined as the ratio between their largest dimension and their smallest dimension, in the range about 5 to 500.

5. A composition according to claim 1, in which the concentration by volume of said particles is in the range 1% to 50% with respect to the total volume.
